(19) United States
(12) Patent Application Publication
(10) Pub. No.: US 2016/0327498 A1
(43) Pub. Date: Nov. 10, 2016

(54) MATERIAL EVALUATION DEVICE AND METHOD

(71) Applicant: FUJITSU LIMITED, Kawasaki-shi (JP)

(72) Inventors: Hideshi Yamaguchi, Atsugi (JP); Takeshi Soeda, Kawasaki-shi (JP)

(73) Assignee: FUJITSU LIMITED, Kawasaki-shi (JP)

(21) Appl. No.: 15/213,913

(22) Filed: Jul. 19, 2016

Related U.S. Application Data
(63) Continuation of application No. PCT/JP2014/052536, filed on Feb. 4, 2014.

(51) Int. Cl. G01N 23/225

(52) U.S. Cl. CPC G01N 23/2251

(57) ABSTRACT

A detector is the one which detects reflected electrons or secondary electrons emitted from a sample as a result of irradiation with an electron beam by an electron beam irradiation unit, and its one end is set into a non-contact state where it is separated from and faces the sample and the other end is supported on and fixed to a drive mechanism, and the drive mechanism freely moves the detector random positions three-dimensionally with respect to the sample. According to this configuration, it is possible to detect reflected electrons and secondary electrons scattered in random directions appropriately, and accurate evaluation of a crystal grain diameter in which no crystal grain boundary is overlooked and acquisition of an isotropic surface shape image are achieved.

### CROSS-REFERENCE TO RELATED APPLICATION

This application is a continuation application of International Application PCT/JP2014/052536 filed on Feb. 4, 2014 and designated the U.S., the entire contents of which are incorporated herein by reference.

### FIELD

The embodiment discussed herein is directed to a material evaluation device and method.

### BACKGROUND

In development of various materials and electronic devices, a crystal grain diameter and a surface shape of a composing material are very important information. There is a scanning electron microscope (SEM) as one of devices suitable for evaluating such information.

[Patent Document 1] Japanese Laid-open Patent Publication No. 10-214584

[Patent Document 2] Japanese Laid-open Patent Publication No. 2000-321224

[Patent Document 3] Japanese Laid-open Patent Publication No. 2007-3352

FIG. 1 illustrates a schematic configuration of a conventional SEM. In the SEM, generally, reflected electrons scattered at high angles reflect much crystal orientation information, and they are detected by a disk-shaped high-angle detector 101. However, because the high-angle detector 101 has a disk shape, the reflected electrons scattered at the same angle are isotropically detected. On the other hand, secondary electrons scattered at low angles reflect much surface shape information, and they are detected by a low-angle detector 102. However, because the low-angle detector 102 is disposed in one predetermined direction, only the secondary electrons scattered in the direction are highlighted and detected.

FIG. 2A illustrates a reflected electron image of platinum acquired by the SEM. In FIG. 2A crystal grains of the platinum appear as a difference in contrast, and it is possible to evaluate a crystal grain diameter from this image. This is because when electrons which are made incident inside a sample are emitted as the reflected electrons, a difference in the reflected electrons occurs depending on crystal orientations as illustrated in FIG. 2B. However, in evaluating the crystal grain diameter, there is a case where the contrast in the reflected electron image of adjacent crystals is accidentally almost the same. In this case, there is a problem in that it is difficult to visually recognize a crystal grain boundary from the reflected electron image and the crystal grain boundary is overlooked and the adjacent crystals are recognized as one large crystal.

FIG. 3 illustrates a secondary electron image of a quadrangular projecting portion acquired by the SEM. In FIG. 3, the projecting portion can be recognized to be a projecting shape but is an image which appears to be illuminated from the upper right of the plane in FIG. 3, and therefore there is a problem in that an isotropic surface shape image is not acquirable.

### SUMMARY

One aspect of a material evaluation device includes: an electron beam irradiation unit which irradiates a sample with an electron beam; a detector which detects electrons emitted from the sample as a result of the irradiation with the electron beam; and a moving mechanism which freely varies a position of the detector with respect to the sample while setting the detector into a non-contact state where the detector is separated from the sample.

One aspect of a material evaluation method is a material evaluation method by using a device which includes: an electron beam irradiation unit which irradiates a sample with an electron beam; and a detector which detects electrons emitted from the sample as a result of the irradiation with the electron beam, the material evaluation method including detecting the electrons at a plurality of different positions, by making a position of the detector with respect to the sample variable while setting the detector into a non-contact state where the detector is separated from the sample.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic view illustrating a schematic configuration of a conventional SEM;

FIG. 2A is a view illustrating a picture of a reflected electron image of platinum acquired by an SEM;

FIG. 2B is a schematic view for explaining that a difference in reflected electrons occurs depending on crystal orientations;

FIG. 3 is a view illustrating a picture of a secondary electron image of a quadrangular projecting portion acquired by the SEM;

FIG. 4 is a schematic view illustrating a schematic configuration of a material evaluation device according to this embodiment;

FIG. 5 is a flowchart illustrating a material evaluation method according to this embodiment in the order of steps;

FIG. 6 is a view illustrating a picture of a reflected electron image acquired according to this embodiment;

FIG. 7 is a flowchart illustrating a method for calculating a crystal grain diameter of a crystalline sample according to this embodiment in the order of steps;

FIG. 8A is a schematic view illustrating a reflected electron image at a position A according to this embodiment;

FIG. 8B is a schematic view illustrating a reflected electron image at a position B according to this embodiment;

FIG. 8C is a schematic view illustrating a crystal grain distribution image acquired by arithmetic processing of the reflected electron image in FIG. 8A and the reflected electron image in FIG. 8B;

FIG. 9 is a flowchart illustrating a method for creating a surface shape image according to this embodiment in the order of steps;

FIG. 10A is a schematic view illustrating a secondary electron image at a position A according to this embodiment;

FIG. 10B is a schematic view illustrating a secondary electron image at a position B according to this embodiment; and

FIG. 10C is a schematic view illustrating a surface shape image acquired by arithmetic processing of the secondary electron image in FIG. 10A and the secondary electron image in FIG. 10B.

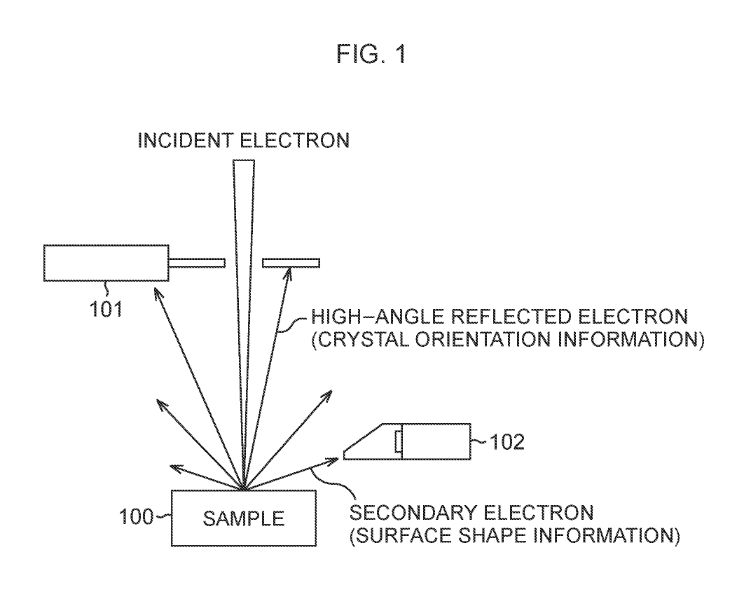

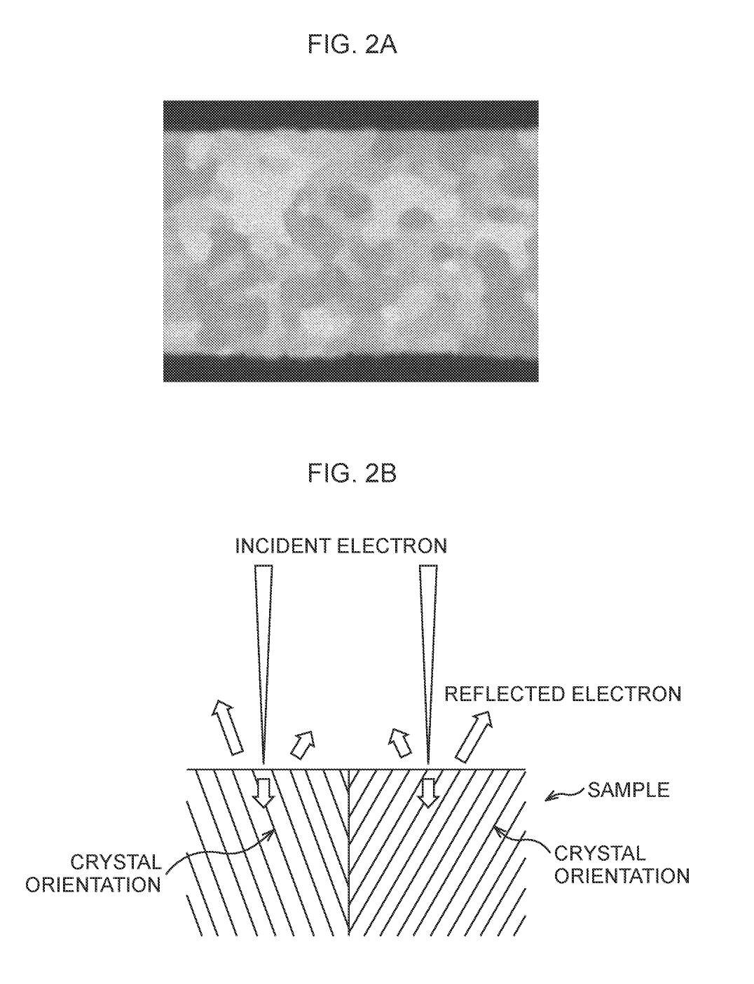

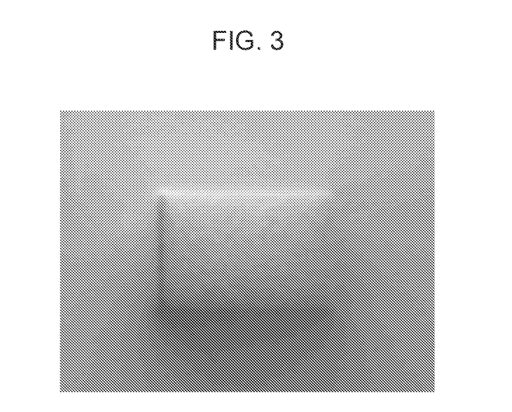

### DESCRIPTION OF EMBODIMENTS

Hereinafter, a specific embodiment of a material evaluation device and method will be described in detail referring to the drawings. In this embodiment, an example in which the material evaluation device and method is applied to an SEM is provided, but it can also be applied to, for example, a transmission electron microscope (TEM), an Auger electron spectrometer (AES), an electron probe microanalyzer (EPMA), and the like without being limited to this.

(Configuration of the Material Evaluation Device)

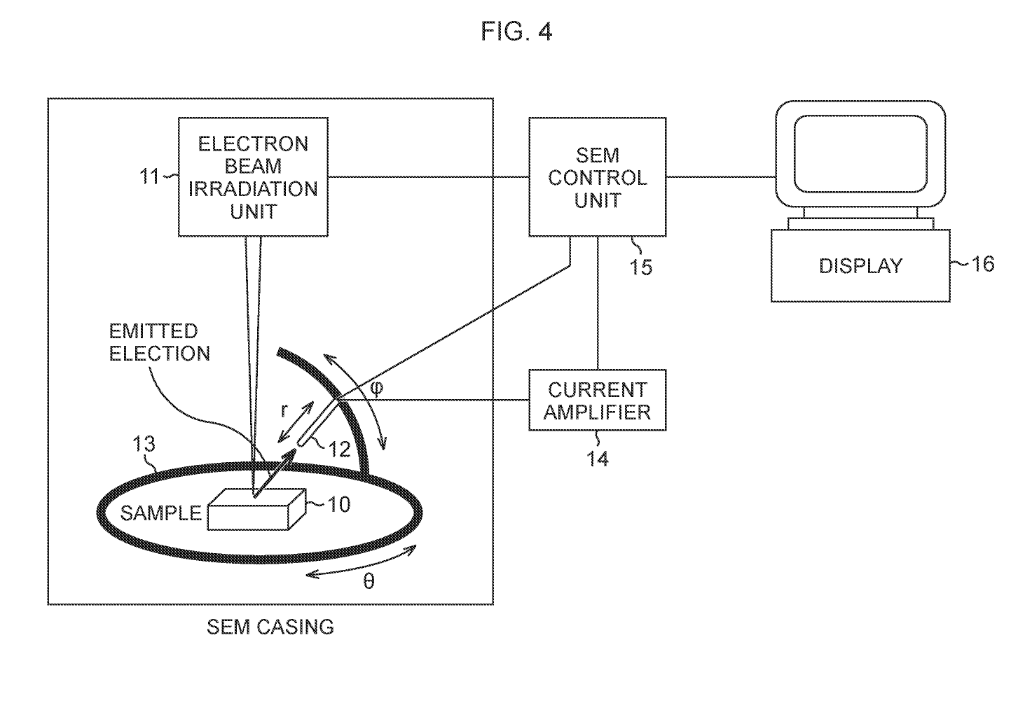

FIG. 4 is a schematic view illustrating a schematic configuration of the material evaluation device according to this embodiment.

This material evaluation device is configured to include an electron beam irradiation unit 11, a detector 12, and a drive mechanism 13 provided in an SEM casing, and a current amplifier 14, an SEM control unit 15, and a display 16.

The electron beam irradiation unit 11 has a predetermined lens thereinside and irradiates a sample 10 with an electron beam focused through the lens, and scans the surface of the sample 10.

The detector 12 is the one which detects electrons emitted from the sample 10 as a result of the irradiation with the election beam by the electron beam irradiation unit 11 (reflected electrons or secondary electrons) and is a conductive member such as metal which is needle-shaped (for example, about 20 μm in tip diameter) in shape. To the detector 12, a bias voltage of about −50 V to about 0 V is applied when reflected electrons are detected, and a bias voltage of about +1 V or more is applied thereto when secondary electrons are detected. In the detector 12, its one end is set into a non-contact state where it is separated from and faces the sample 10, and the other end is supported on and fixed to the drive mechanism 13. Note that the detectors 12 may be plurally disposed on the drive mechanism 13.

The drive mechanism 13 has a motor, a piezoelectric actuator, or the like and is a drive guide which freely moves the detector 12 to random positions three-dimensionally with respect to the sample 10. The drive mechanism 13 makes it possible for the detector 12 to exhibit functions of a reflected electron detector and a secondary electron detector and for the detector 12 to detect electrons scattered in random directions (reflected electrons or secondary electrons). In this embodiment, the drive mechanism 13 freely moves the detector 12 in triaxial directions r, θ, φ of polar coordinates. The drive mechanism 13 makes it possible for one end of the detector 12 to come as close to the sample 10 as about 1 μm or less and for the detector 12 to make a solid angle for detection of the electrons large, resulting in improving detection sensitivity to the electrons. Because the detector 12 detects an electron which comes flying to the drive mechanism 13 if the detector 12 is electrically connected to the drive mechanism 13, the drive mechanism 13 and the detector 12 are made electrically non-continuous.

The current amplifier 14, regarding the electrons detected by the detector 12, amplifies current and converts it into voltage to generate an electrical signal, which is transmitted to the SEM control unit 15.

The display 16 displays an emitted electron image (reflected electron image or secondary electron image) acquired by the SEM control unit 15.

The SEM control unit 15 controls the electron beam irradiation by the electron beam irradiation unit 11, the electron detection by the detector 12, the movement of the detector 12 by the drive mechanism 13, and the image display on the display. The SEM control unit 15, to which the electrical signal from the current amplifier 14 is input through an external input terminal, synchronizes the input electrical signal with the electron beam scan of the electron beam irradiation unit 11 to acquire the emitted electron image, and displays it on the display 16.

(Evaluation Method by Using the Material Evaluation Device)

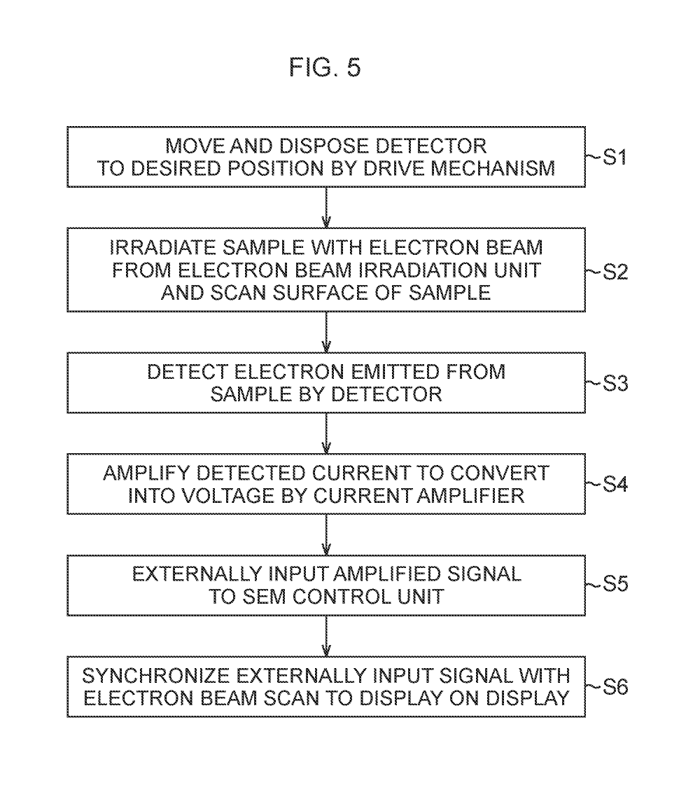

Hereinafter, an evaluation method by using the material evaluation device configured as described above will be described. FIG. 5 is a flowchart illustrating the material evaluation method according to this embodiment in the order of steps.

First, the SEM control unit 15 moves the detector 12 to a desired position and halts it by controlling the drive mechanism 13 (Step S1). Disposition points of the detector 12 are set at predetermined high-angle positions at large φ angles when the reflected electrons scattered at high angles are detected and are set at predetermined low-angle positions at small φ angles when the secondary electrons scattered at low angles are detected.

Subsequently, the SEM control unit 15 makes the electron beam irradiation unit 11 irradiate the sample 10 with the electron beam and scan the surface of the sample 10 by controlling the electron beam irradiation unit 11 (Step S2).

Subsequently, the detector 12 detects electrons emitted from the sample 10 as a result of the irradiation with the electron beam by the electron beam irradiation unit 11 (reflected electrons or secondary electrons) (Step S3).

Subsequently, the current amplifier 14, regarding the electrons detected by the detector 12, amplifies current and converts it into voltage to generate an electrical signal, which is transmitted to the SEM control unit 15 (Step S4).

Subsequently, to the SEM control unit 15, the electrical signal from the current amplifier 14 is input through the external input terminal (Step S5).

Subsequently, the SEM control unit 15 synchronizes the input electrical signal with the electron beam scan of the electron beam irradiation unit 11 to acquire an emitted electron image, and displays it on the display 16 (Step S6).

Note that when a material evaluation device in which the detectors 12 are plurally disposed on the drive mechanism 13 is used, it is considered to dispose each detector 12 at each of a plurality of different points in Step S1 and carry out Steps S2 to S6 for each detector 12, for example, at the same time. This makes it possible to acquire a plurality of different emitted electron images at the same time.

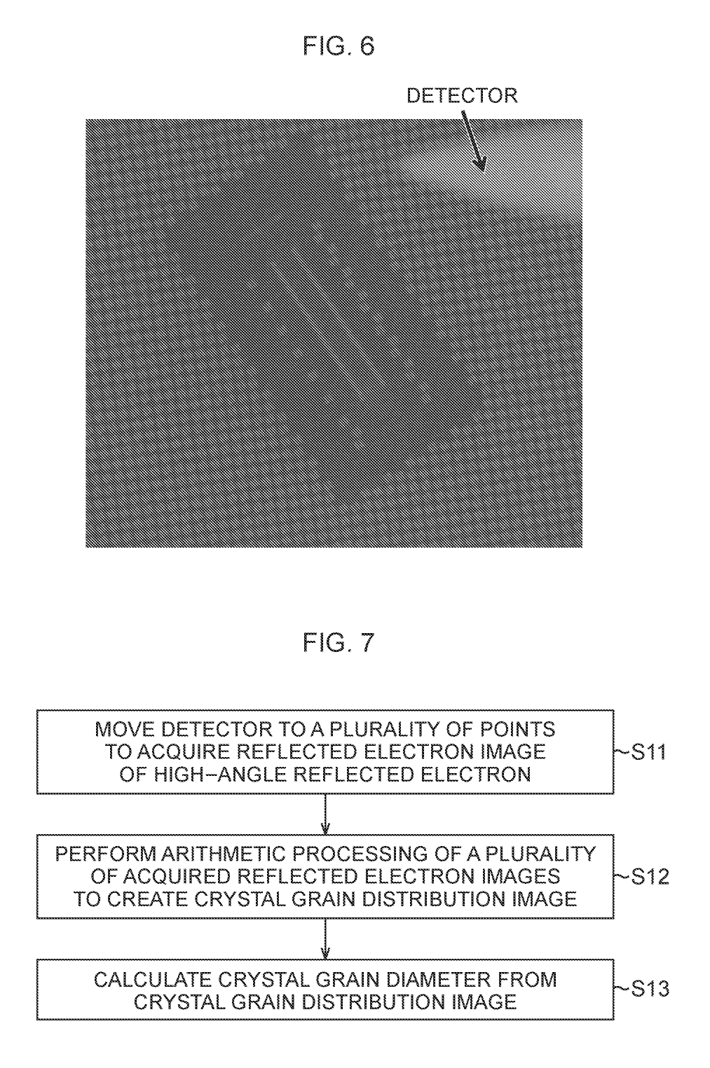

FIG. 6 illustrates one example of a reflected electron image acquired according to this embodiment as the emitted electron image. In a field of view in FIG. 6, a detector which detects reflected electrons and is a metal probe made of tungsten exists. In actual SEM observation, the detector need not exist in the field of view and may be disposed at a predetermined position near the field of view.

(Calculation Method for a Crystal Grain Diameter of a Crystalline Sample)

FIG. 7 is a flowchart illustrating a method for calculating a crystal grain diameter of a crystalline sample according to this embodiment in the order of steps. Here, the sample 10 in FIG. 4 is set as a predetermined crystalline sample.

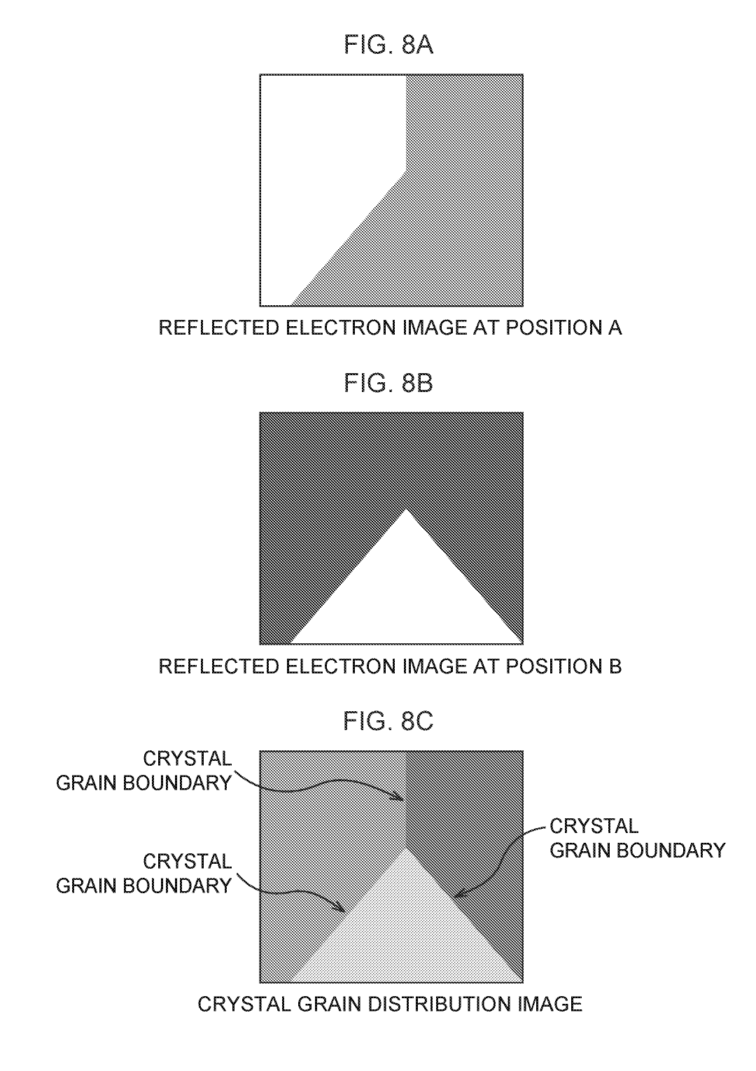

The drive mechanism 13 moves the detector 12 to a plurality of different positions with respect to the sample 10 and reflected electrons emitted from the sample 10 as a result of the irradiation with the electron beam by the electron beam irradiation unit 11 are detected at the respective positions under the control by the SEM control unit 15 in Steps S1 to S3 in FIG. 5. In this case, the plurality of positions of the detector 12 are each a predetermined high-angle position at a large θ angle. The SEM control unit 15 acquires reflected electron images corresponding to the plurality of different positions in Steps S4 to S6 in FIG. 5 (Step S11). For example, FIG. 8A illustrates the reflected electron image at a position A, and FIG. 8B illustrates the reflected electron image at a position B different from the position A, respectively. The acquired reflected electron images are different from each other in contrasts depending on the positions of the detector 12.

Subsequently, the SEM control unit 15 performs arithmetic processing of the plurality of acquired reflected electron images to create a crystal grain distribution image (Step S12). FIG. 8C illustrates the crystal grain distribution image combined by the arithmetic processing of the reflected electron image in FIG. 8A and the reflected electron image in FIG. 8B. In the crystal grain distribution image in FIG. 8C, it becomes possible to recognize crystal grain boundaries which are visually unrecognizable and overlooked in the respective reflected electron images in FIG. 8A and FIG. 8B.

Subsequently, the SEM control unit 15 calculates a crystal grain diameter from the crystal grain distribution image acquired by the arithmetic processing (Step S13).

Note that when the material evaluation device in which the detectors 12 are plurally disposed on the drive mechanism 13 is used, it is considered to dispose each detector 12 at each of a plurality of different points in Step S1 and carry out Steps S11 to S12 for each detector 12, for example, at the same time. This makes it possible to acquire the respective reflected electron images (reflected electron images in FIG. 8A and FIG. 8B in the above-described example) at the plurality of different points at the same time and acquire a crystal grain distribution image efficiently in a short time.

(Creation Method for a Surface Shape Image)

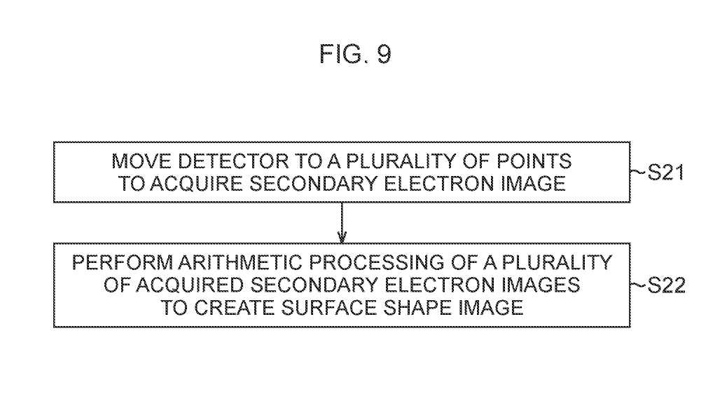

FIG. 9 is a flowchart illustrating a method for creating a surface shape image according to this embodiment in the order of steps. Here, the sample 10 in FIG. 4 is set as a sample in which a fine quadrangular projecting portion is formed on the surface.

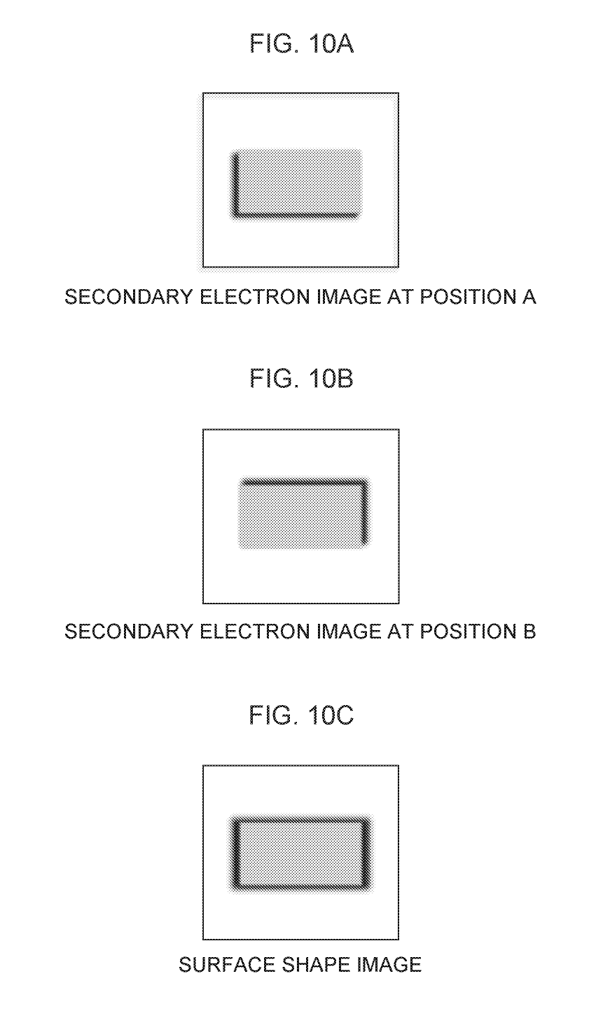

The drive mechanism 13 moves the detector 12 to a plurality of different positions with respect to the sample 10 and secondary electrons emitted from the sample 10 as a result of the irradiation with the electron beam by the electron beam irradiation unit 11 are detected at the respective positions under the control by the SEM control unit 15 in Steps S1 to S3 in FIG. 5. In this case, the plurality of positions of the detector 12 are each a predetermined low-angle position at a small φ angle. The SEM control unit 15 acquires secondary electron images corresponding to the plurality of different positions in Steps S4 to S6 in FIG. 5 (Step S21). For example, FIG. 10A illustrates the secondary electron image at a position A, and FIG. 10B illustrates the secondary electron image at a position B different from the position A, respectively. The acquired secondary electron images are different from each other in contrasts depending on the positions of the detector 12.

Subsequently, the SEM control unit 15 performs arithmetic processing of the plurality of acquired secondary electron images to create a surface shape image (Step S22). FIG. 10C illustrates the surface shape image combined by the arithmetic processing of the secondary electron image in FIG. 10A and the secondary electron image in FIG. 10B. In FIG. 10C, an isotropic surface shape image is acquired differently from the respective secondary electron images in FIG. 10A and FIG. 10B.

Note that when the material evaluation device in which the detectors 12 are plurally disposed on the drive mechanism 13 is used, it is considered to dispose each detector 12 at each of a plurality of different points in Step S1 and carry out Steps S21 to S22 for each detector 12, for example, at the same time. This makes it possible to acquire the respective secondary electron images (secondary electron images in FIG. 10A and FIG. 10B in the above-described example) at the plurality of different points at the same time and acquire a surface shape image (in FIG. 10C in the above-described example) efficiently in a short time.

As described above, according to this embodiment, one detector 12 allows reflected electrons and secondary electrons scattered in random directions to be detected appropriately and achieves accurate evaluation of a crystal grain diameter in which no crystal grain boundary is overlooked and acquisition of an isotropic surface shape image. Because the detector 12 and the drive mechanism 13 can be retrofitted to an existing material evaluation device, there is a merit also in terms of cost, and because they can be easily removed, there is a merit in terms of maintenance as well.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

According to the embodiment, it is possible to detect reflected electrons and secondary electrons scattered in random directions appropriately, and accurate evaluation of a crystal grain diameter in which no crystal grain boundary is overlooked and acquisition of an isotropic surface shape image are achieved.

What is claimed is:

1. A material evaluation device comprising:
an electron beam irradiation unit which irradiates a sample with an electron beam;
a detector which detects electrons emitted from the sample as a result of the irradiation with the electron beam; and
a moving mechanism which freely varies a position of the detector with respect to the sample while setting the detector into a non-contact state where the detector is separated from the sample.

2. The material evaluation device according to claim 1,
wherein the detector detects the electrons emitted from the sample at a plurality of different positions with respect to the sample, the material evaluation device further comprising
an arithmetic processing unit which performs arithmetic processing of a signal of the electrons detected by the detector at the plurality of positions.

3. The material evaluation device according to claim 2,
wherein the arithmetic processing unit creates a crystal grain distribution image of the sample from each of the signals and calculates a crystal grain diameter of the sample from the crystal grain distribution image.

4. The material evaluation device according to claim 2,
wherein the arithmetic processing unit creates an image of a surface shape of the sample from each of the signals.

5. The material evaluation device according to claim 1,
wherein the detector is needle-shaped in shape.

6. The material evaluation device according to claim 1,
wherein the detectors are plurally disposed.

7. A material evaluation method by using a device, the device comprising:
an electron beam irradiation unit which irradiates a sample with an electron beam; and
a detector which detects electrons emitted from the sample as a result of the irradiation with the electron beam, the material evaluation method comprising
detecting the electrons at a plurality of different positions, by making a position of the detector with respect to the sample variable while setting the detector into a non-contact state where the detector is separated from the sample.

8. The material evaluation method according to claim 7,
wherein the detector detects the electrons emitted from the sample at the plurality of different positions with respect to the sample, the material evaluation method further comprising
performing arithmetic processing of a signal of the electrons detected by the detector at the plurality of positions.

9. The material evaluation method according to claim 8, further comprising
creating a crystal grain distribution image of the sample from each of the signals and calculating a crystal grain diameter of the sample from the crystal grain distribution image.

10. The material evaluation method according to claim 8, further comprising
creating an image of a surface shape of the sample from each of the signals.

11. The material evaluation method according to claim 7,
wherein the detector is needle-shaped in shape.

12. The material evaluation method according to claim 7,
wherein the detectors are plurally disposed.
